(19) United States
(12) Patent Application Publication
(10) Pub. No.: US 2008/0134268 A1
(43) Pub. Date: Jun. 5, 2008

(54) Multimedia broadcasting system, device, and operation method

(76) Inventors: Ming-shen Sun, Hsinchu (TW); Hwei-tsu Luh, Hsinchu (TW)

Correspondence Address: Hwei-tsu Luh, 33, Ln.100, ShuangYuan Rd., Paoshan, Hsinchu county, omitted

(21) Appl. No.: 11/737,724

(22) Filed: Apr. 19, 2007

(30) Foreign Application Priority Data
Nov. 30, 2006 (TW) 095144303

(51) Int. Cl. H04N 7/173

(52) U.S. Cl. 725/114

(57) ABSTRACT

This invention is related to a multimedia broadcasting system and device. The system comprises a server and a plurality of broadcasting device. The broadcasting devices are connected to the server through a proxy server and network interface. The server build in a network database, a customer database, a content database, a interactive record database, a network manage interface and a content manage interface. The broadcasting device builds in a operation system and a user interface. The multimedia broadcasting system and device provide user to watch TV, browsing web and information interaction.

### FIELD OF INVENTION

The present invention relates to a networked multimedia broadcasting system and device, in which individual device connects to a server. In particular, the invention relates to kiosk newsstands.

### BACKGROUND OF THE INVENTION

Known information systems (such as POI or kiosk) generally provide individual publicly accessible computer based system even users who are not trained in operation can rapidly call up information and conduct transactions. The data in the case can be present as discrete (such as text and graphics) and as continuous media (such as audio and video). However, these information systems have some problems:

(1) Content updating: although most of the information systems are networked, but do not have a total solution for content updating.

(2) Content diversification: above described information system are set for sales purpose, the provided contents are purchasing information or advertisement. The client terminal does not allow user to browse the internet, even with the network function.

(3) User operation feedback: for content provider, the information systems are communication interface between users and content providers. If the information systems can get the user feedback directly, may use for content adjustment.

U.S. Pat. No. 5,993,725 discloses networked multimedia information systems providing user real-time updating information. The server terminal will provide different contents or multimedia files base on client terminal configuration. Each change on server terminal database will transfer to every client terminal. This patent solve the problem of content updating, however, the updating method will increase the loading of the server terminal. And real-time updating may effect the user's operation (for example: if the file or page changes, user can't find the corresponding content).

U.S. Pat. No. 7,072,849 discloses an interactive advertisement, integrated an advertisement page in the server application software. And the advertisement page provides user real-time interactive function when user operates the kiosk. Or server terminal provides related advertisement to the kiosk base on user configuration. However, this patent does not provide the feedback of user operation record.

### SUMMARY OF THE INVENTION

The present invention provides users a multi-function information system such as: watching TV, internet browsing and information interaction. The invention also provides a multimedia broadcasting system and device, the information (advertisement) provider can promote or sell product through the device. And the multimedia broadcasting device will get the user order record and pass to the server, information provider can adjust the information accordingly. The server connects to a plurality of multimedia broadcasting devices and provides the specific information (advertisement) at the specific time period or specific group of multimedia broadcasting devices.

### BRIEF DESCRIPTION OF THE DRAWINGS

FIG. 1 shows the networked structure of a server and multimedia broadcasting devices.

FIG. 2 is a functional block diagram of the invention.

FIG. 3 is an operation flow chart of the multimedia broadcasting device.

FIG. 4 shows the system structure of the invention.

FIG. 5 is an operation flow chart of the server.

FIG. 6 is an operation flow chart of the first embodiment.

FIG. 7 is an operation flow chart of the second embodiment.

### DESCRIPTION OF THE EMBODIMENTS

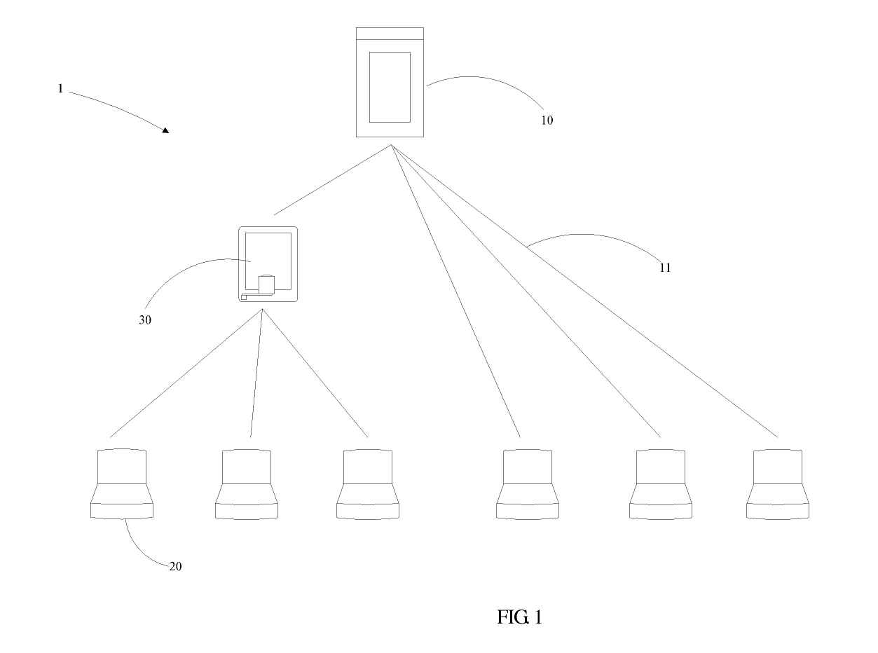

The networked structure of a server and multimedia broadcasting devices are shown in FIG. 1. The multimedia broadcasting system 1 comprises a server 10 and a plurality of multimedia broadcasting devices 20 (so called client terminal). Wherein the server 10 connects to a plurality of multimedia broadcasting devices 20 by network interface 11 directly, or the multimedia broadcasting devices 20 connect to a proxy server 30, and the proxy server 30 connects to the server 10. The same information will be downloaded and stored in the proxy server 30, then pass to each multimedia broadcasting devices 20 for media display. The kind of networked structure can reduce to loading of the network interface 11.

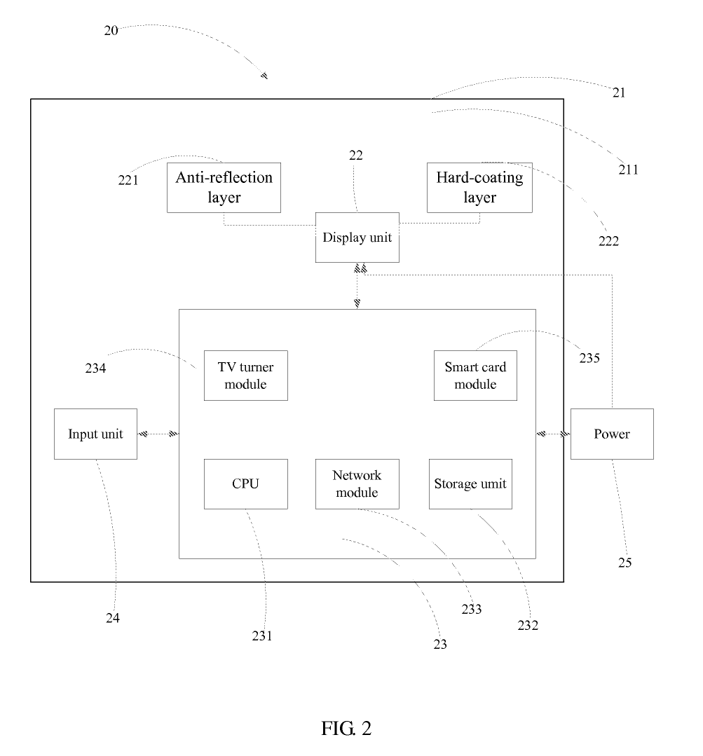

FIG. 2 is a functional block diagram of the invention. The multimedia broadcasting device 20 comprises: a casing 21, the casing 21 set up a storage space 211; a display unit 22 install in the storage space 211 to display a media file. The display unit 22 usually is a LCD module or touch panel module, and the cover of the display unit 22 includes an anti-reflection layer 221 for user operation convenience. Additionally, the display unit 22 further includes a hard-coating layer 222 to avoid the friction. A printed circuit broad 23 is installed in the storage space 211 and connects to the display unit 22. The printed circuit broad 23 includes a CPU 231, a storage unit 232, a network module 233 and a TV turner module 234. The network module 233 can be an ADSL, cable or WLAN. The printed circuit broad 23 further includes a smart card module 235 for user identification. An input unit 24 connects to the printed circuit broad 22, and the input unit 24 can be a keyboard, a keypad or a touch panel. A power unit 25 also connects to the display unit 22 and printed circuit broad 23 for power supply.

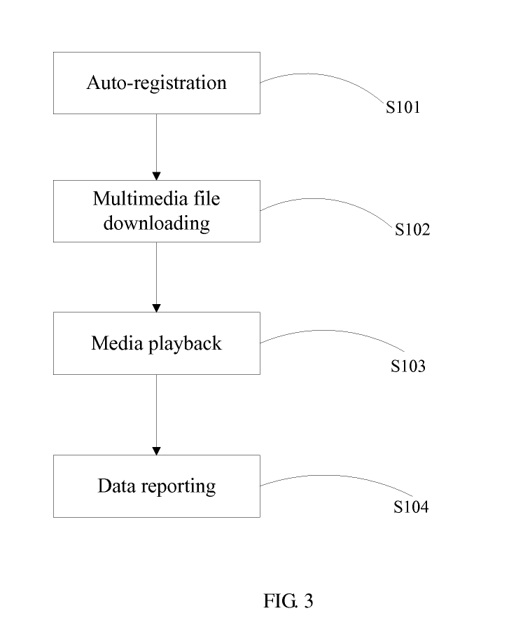

Refer to FIG. 3 is an operation flow chart of the multimedia broadcasting device. The multimedia broadcasting device (so called: customer terminal) can be a stand along device or a networked broadcasting device. When stand along, the multimedia broadcasting device display the multimedia file stored in the storage unit. When connect to a server, comprising the following steps:

(a) Auto-registration S101: upon turning on the multimedia broadcasting device 20 and the device 20 is connected to the network 11, the multimedia broadcasting device 20 should be automatically executed the verification to upload a verified information to the server 10. The verified information comprising: a customer terminal serial no., a network IP, an installation location, an installation history and an active data.

(b) Multimedia file downloading S102: as the multimedia broadcasting device 20 is verified by the server 10, the multimedia broadcasting device 20 download a multimedia file from the server 10 and store it in the storage unit 232. The multimedia file comprising a play list and at least a play content, the play content can be still images, audio clips, video clips or multimedia flash files for advertisement purpose.

(c) Media playback S103: the multimedia broadcasting device 20 plays the play list and the play content stored in the storage unit 232, or user can interact with the content.

(d) Data reporting S104: the multimedia broadcasting device 20 reports daily (or a period of time) to the server 10 the recorded “play-record” and “activity-record”.

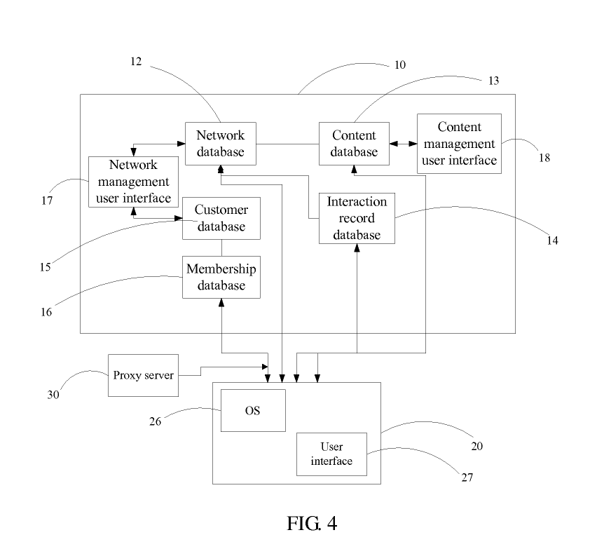

FIG. 4 shows the system structure of the invention. The present invention comprises a server 10 and multimedia broadcasting devices 20 (customer terminals). The multimedia broadcasting devices are connected by a proxy server 30 and the proxy server 30 connects to the server 20. The proxy server 30 serves as the buffer between each multimedia broadcasting device 20 and the server 10. It stores and updates daily (or period of time) the content distributed by the server 20. The server 20 contains a network database 12, a content database 13, an interaction record database 14, a customer database 15, a membership database 16, a network management user interface 17, a content management user interface 18. The network database 12 includes IDs of each multimedia broadcasting device 20, status of the device 20, installation location (which will be related to the specific customer) and ID of the proxy server 30, feature of the device 20 (does it has built-in camera or other special feature), service history (how long has the device 20 been installed, has it been used in many different location?). The content database 13 is the central (or vaulted) data storage of all content to be displayed in each multimedia broadcasting device 20. The content may include (but not limited to): still images, video clips or video playback, dynamic web pages (HTML files or flash contents). Together with the content, the owner's information of this content will also be included (a pointer to the customer database 15), and also where and when this content will be played (pointers to the play lists that “requested” this content). The interaction record database 14 is to store the interaction record of each multimedia broadcasting device 20 that will be used for later reporting and data analysis. Like the traction record, when and how the preloaded contents in a specific device 20 are played is record in a “play log” which has the device 20 ID and the time and the content ID that was played in specific day. Also during that period of time, all activity related to the played content is record in an “activity log”. The “play log” and “activity log” will be reported to the server 10 in a daily bases. The customer database 15 stores the information related to specific customers. The customers usually are companies that have business transaction with the multimedia broadcasting system 1. Three types of customers include:

a. Installation Customer
Customers who install multimedia broadcasting device 20 are often a chain store brand, or an independent store, or the manager of some public facility.

b. Advertising Customer
Customers buy the time spots of the device 20 in the network, and want to put advertisement on the device 20 during its operation.

c. Other Channel Customer
Customer also utilize the multimedia broadcasting system 1 to sell their products or service, such as content providers (music or video content), or payment service providers (iCash, PayEasy or Paypal).

The Membership database 16 stores the information of specific members. Related information includes personal data (name, gender, data of birth, address, email, etc) membership type (different category of member ship, joint membership), feature set related to this member. The network management user interface 17 is for the system 1 managers or the IT managers of the authorized customers to access the network database 12, the customer database 13 and the membership database 15. Management activities such as: add/edit/delete customers, add/edit/delete installation locations, add/edit/delete device 20, monitor the operation of the device 20. The content management user interface 18 is designed for the customer (including installation customer, advertising customer and channel customer) to construct, upload and manage the contents to be broadcast through the network. It should include an interactive editing tool for content (advertisement, etc), tools to schedule, monitor, and query the replay of the content on the specified device 20.

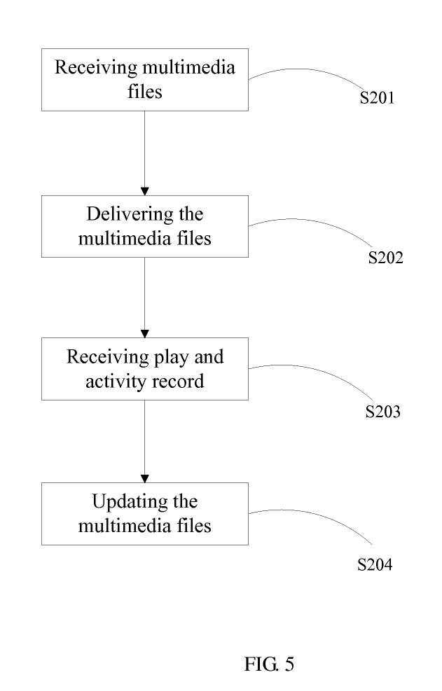

FIG. 5 shows the operation steps of the server, the operation steps comprising:

(a) Receiving multimedia files S201: the content provider (including installation customer, advertising customer and channel customer) will upload multimedia files (list and contents) to the server 10 and store in the content database 13;

(b) Delivering the multimedia files S202: once a verified information of the multimedia broadcasting device 20 has been approved by the server 10, the server 10 will deliver the multimedia files to the multimedia broadcasting device 20. The verified information comprising: a customer terminal serial no., a network IP, an installation location, an installation history and an active data.

(c) Receiving play and activity record S203: the multimedia broadcasting device 20 will upload a daily play and activity record to the server 10 and store in the interaction record database 14.

(d) Updating the multimedia files S204: the server 10 will compare the installation history and activity record of each multimedia broadcasting device 20 to update the multimedia files.

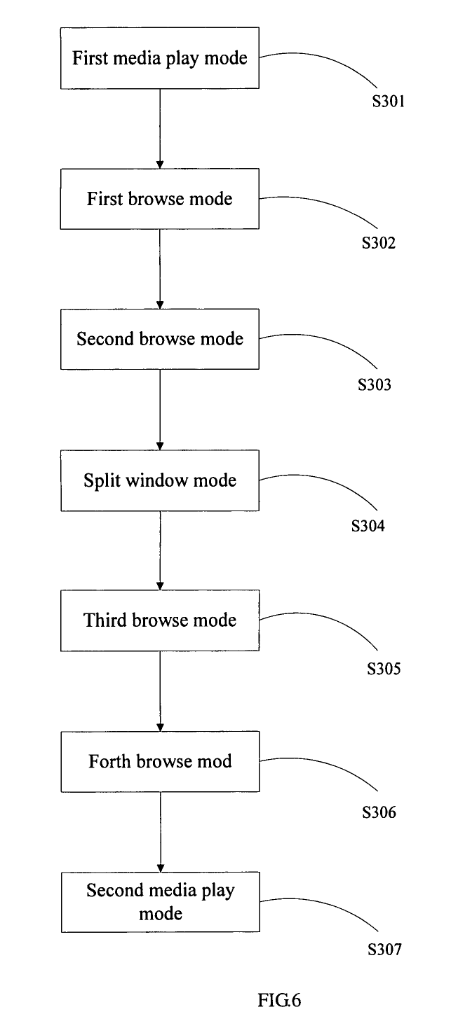

FIG. 6 is an operation flow chart of the preferred embodiment. This invention can be used in chain stores, hair salons or a public place. The preferred embodiment is used in a chain store of fast food, the multimedia broadcasting device comprising the following steps:

(a) First media play mode S301: when the multimedia broadcasting device 20 is turned on everyday, after “anto-registration” and “content downloading”, it will start to play the preloaded media files.

(b) First browse mode S302: when any of control buttons is activated, the device 20 will enter the top level menu where the general service items are listed in the “service menu panel” which is highlighted as the “active window”. User can select an application or enter the next level of menu.

(c) Second browse mode S303: when user choose this function from the top level menu, the device 20 will bring up a window containing selectable menu items (including meal, drink, desert, etc). This window will become the active window for user selection and showing the total money amount of this purchase order.

(d) Split window mode S304: while waiting the order to be delivered, the customer may choose to watch TV and the device 20 will enter this mode. The screen is divided into a main screen (about ⅘) to show the TV and a sub screen (about ⅕) to present the advertisement.

(e) Third browse mode S305: the customer can also choose to browse other contents provided by the store (such as: company history, nutrition tips, special recipe and internet news).

(f) Forth browse mode S306: the store often would like to collect customer feedback by using a customer survey form. When enter this mode, a window shows all the questions.

(g) Second media play mode S307: when the device 20 is not in the browse mode and unattended for a period of time (about 10 minutes), the device will regard that the user is not using it anymore, and automatically trigger the media play mode to show full screen advertisements or media files.

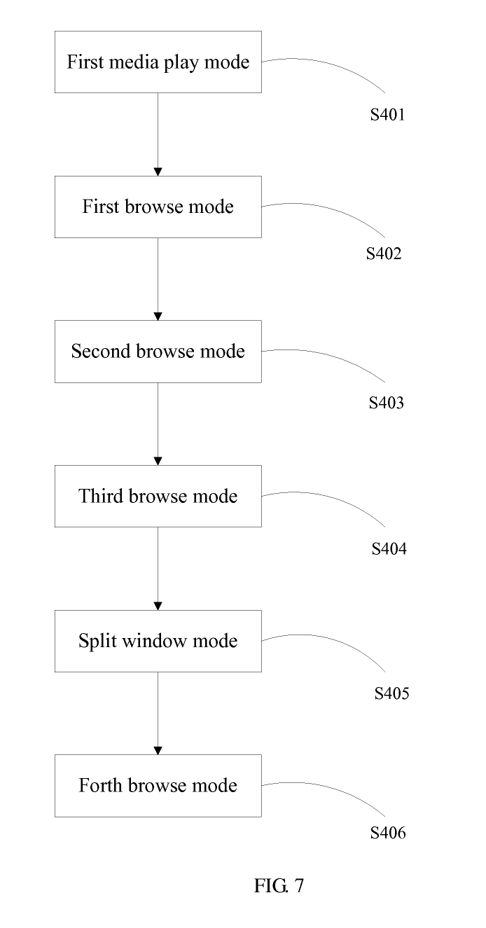

FIG. 7 is an operation flow chart of the second embodiment. Hair salon is another application of this invention, the operation flow chart comprises the following steps:

(a) First media play mode S401: when the multimedia broadcasting device 20 is turned on everyday, after “anto-registration” and “content downloading”, it will start to play the preloaded media files.

(b) First browse mode S402: when any of control buttons is activated, the device 20 will enter the top level menu where the general service items are listed in the “service menu panel” which is highlighted as the “active window”. User can select an application or enter the next level of menu.

(c) Second browse mode S403: the service person uses this mode to let a customer choose the hair style they want. Different hairstyles are present in the multimedia broadcasting device 20 for user selection.

(d) Third browse mode S404: this mode brings up the window with the information of their special promotion package. The service can use this as a sales tool with less effort.

(e) Split window mode S405: when the customer is waiting for their hair to be done, they can switch to TV mode to watch TV. One special case is that when the waiting time is going to be long, the hair salon may want to offer movies viewing as a free or charged service to the customer.

(f) Forth browse mode S406: the customer can also choose to browse other contents provided by the store (such as: company history, health information, fashion information, and internet news).

What is claim is:

1. A multimedia broadcasting device with networked function, the device comprising:
a casing, the casing sets a storage space;
a display unit is installed in the storage space;
a printed circuit broad is installed in the storage space and connects to the display unit, the printed circuit broad includes a CPU, a storage unit, a network module and a TV turner nodule;
a input unit connects to the printed circuit broad.

2. The multimedia broadcasting device in accordance claim 1, the display unit is a LCD display.

3. The multimedia broadcasting device in accordance claim 1, the display unit is a touch panel.

4. The multimedia broadcasting device in accordance claim 1, the display unit further includes an anti-reflection layer.

5. The multimedia broadcasting device in accordance claim 1, the display unit further includes a hard-coating layer.

6. The multimedia broadcasting device in accordance claim 1, the network module is an ADSL.

7. The multimedia broadcasting device in accordance claim 1, the network module is a cable.

8. The multimedia broadcasting device in accordance claim 1, the network module is a WLAN.

9. The multimedia broadcasting device in accordance claim 1, the input unit is a keyboard.

10. The multimedia broadcasting device in accordance claim 1, the printed circuit broad further includes a smart card module.

11. An operation method for a customer terminal of a multimedia broadcasting system, the customer terminals are connected to a server and displays a multimedia content. The operation method comprising the following steps:
(a) registering to the server, the customer submits a verified information to the server;
(b) downloading a multimedia file from the server;
(c) displaying the multimedia file;
(d) reporting data to the server a play-record and a activity-record.

12. The operation method in accordance claim II, the customer terminals are connected to a proxy server and the proxy server connects to the server.

13. The operation method in accordance claim 11, the verified information includes a customer terminal serial no., a network IP, an installation location, an installation history and an active data.

14. The operation method in accordance claim 11, the multimedia file comprising a play list and at least a play content.

15. The operation method in accordance claim 11, the customer terminal further comprises an operation system.

16. The operation method in accordance claim 11, the customer terminal is set to update the multimedia file automatically.

17. An operation method for a server of a multimedia broadcasting system, the server connects to customer terminals and manages the information in the customer terminals. The operation method comprising the following steps:
(a) receiving multimedia files;
(b) delivering the multimedia files to each customer terminal base on a verified information;
(c) receiving play and activity record form the customer terminal after a period of time;
(d) Updating the multimedia files in each customer terminal.

18. The operation method in accordance claim 17, the customer terminals are connected to a proxy server and the proxy server connects to the server.

19. The operation method in accordance claim 17, the multimedia files are uploaded by the customer terminals.

20. The operation method in accordance claim 17, the multimedia file comprises a play list and at least a play content.

21. The operation method in accordance claim 17, the verified information comprising: a customer terminal serial no., a network IP, an installation location, an installation history and an active data.

22. The operation method in accordance claim 17, the server compares the installation history of the customer terminal to updates a multimedia file.

23. A multimedia broadcasting system comprising:
a server comprising: a network database, a customer database, and a content database.
a plurality of customer terminals connect to the server, each customer terminal installs an operation system and a user interface, the customer terminal displays a multimedia file and provides interaction with users.

24. The multimedia broadcasting system in accordance claim 23, the network database and the customer database connect to a network management user interface.

25. The multimedia broadcasting system in accordance claim 23, the content database connects to a content management user interface.

26. The multimedia broadcasting system in accordance claim 25, the content management user interface is for uploading a multimedia file.

27. The multimedia broadcasting system in accordance claim 23, the customer database connects to a membership database.

28. The multimedia broadcasting system in accordance claim 23, the customer terminals are connected to a proxy server and the proxy server connects to the server.
